(19) United States
(12) Patent Application Publication
(10) Pub. No.: US 2016/0112852 A1
(43) Pub. Date: Apr. 21, 2016

(54) MOBILE TRAVEL SERVICES

(71) Applicant: THE BOSTON CONSULTING GROUP, INC., Boston, MA (US)

(72) Inventors: Raju SARMA, Manhattan Beach, CA (US); Anthony KOITHRA, New York City, NY (US); Jeff SCHUMACHER, Manhattan Beach, CA (US)

(21) Appl. No.: 14/885,686

(22) Filed: Oct. 16, 2015

Related U.S. Application Data
(60) Provisional application No. 62/065,476, filed on Oct. 17, 2014.

(51) Int. Cl. H04W 4/20; G06Q 50/14; G06Q 20/32; G06Q 20/40; H04L 29/08; H04M 3/42

(52) U.S. Cl. CPC H04W 4/20; H04L 67/18; H04M 3/42; G06Q 20/325; G06Q 20/405; G06Q 50/14; H04W 84/12

(57) ABSTRACT

A mobile device may include a processor, a memory in communication with the processor, a network device in communication with the processor, a display in communication with the processor, and at least one mobile travel service component in communication with that processor. The network device may be configured to communicate with a local network and a public network. The at least one mobile travel service component may be configured to provide mobile travel services via the display and the input device when the network device is out of communication with the public network. The at least one mobile travel service component may include a passenger connect module, a seat swap module, a navigation module, a content module, a retail module, an archive module, an information module, or a combination thereof.

### CROSS-REFERENCE TO RELATED APPLICATIONS

This application claims priority to US Provisional Application No. 62/065,476, filed October 17, 2014, which is incorporated by reference in its entirety.

### BRIEF DESCRIPTIONS OF THE DRAWINGS

FIG. 1 is a network according to an embodiment of the invention.

FIG. 2 is a mobile device according to an embodiment of the invention.

FIG. 3 is a mobile device according to an embodiment of the invention.

FIG. 4 is a set of mobile travel functions according to an embodiment of the invention.

FIG. 5 is a passenger connect function according to an embodiment of the invention.

FIG. 6 is a seat connect function according to an embodiment of the invention.

FIG. 7 is an airport connect function according to an embodiment of the invention.

FIG. 8 is a kids connect function according to an embodiment of the invention.

FIG. 9 is a family connect function according to an embodiment of the invention.

FIG. 10 is a retail connect function according to an embodiment of the invention.

FIG. 11 is a destination connect function according to an embodiment of the invention.

FIG. 12 is a content connect function according to an embodiment of the invention.

FIG. 13 is a platform according to an embodiment of the invention.

FIG. 14 is a network according to an embodiment of the invention.

### DETAILED DESCRIPTIONS OF SEVERAL EMBODIMENTS

The systems and methods described herein may provide travel services to users of mobile devices. For example, passengers on an airplane or other vehicle may be able to access travel services using personal mobile devices. Some or all of these services may be available even if the device is not connected to the Internet while the passenger is in transit. Services may include, but are not limited to, passenger communications, seat swap, navigation, education, entertainment, social network information sharing, retail services, recommendations for the travel destination, and/or media content display.

Systems and methods described herein may comprise one or more computers, which may also be referred to as processors. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. For example, though the term “smartphone” may appear in the specification, the disclosed embodiments are not limited to smartphones.

Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, or other wireless connection). Connections between computers may use any protocols, including connection oriented protocols such as TCP or connectionless protocols such as UDP. Any connection through which at least two computers may exchange data can be the basis of a network.

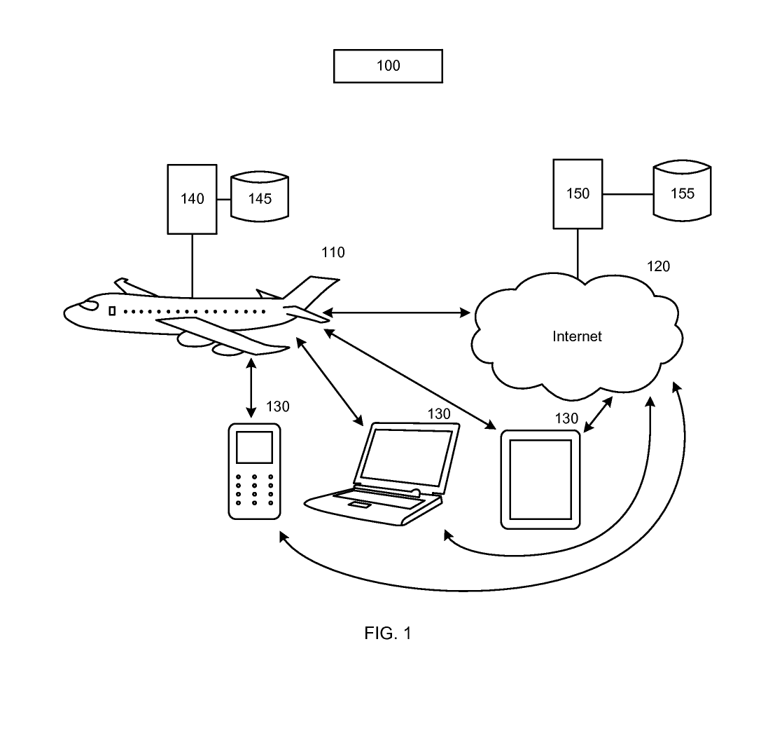

FIG. 1 is a network 100 according to an embodiment of the invention. One or more mobile devices 130 (e.g., smartphones, laptops, tablets, etc.) may be configured to communicate with networks such as the Internet 120 and/or a local network 110 associated with a vehicle such as an airplane. Other vehicles may be used and may comprise: a bus, a train, a boat or any other vehicle holding multiple passengers. One or more servers 140 and databases 145 may be disposed in or associated with the vehicle and may be in communication with the mobile devices 130 via the local network 110. One or more servers 150 and databases 155 may be in communication with the mobile devices 130 via a wider public network such as the Internet 120. As will be described in greater detail below, mobile devices 130 may communicate with one another and/or with servers 150 via the Internet 120 before and after a trip. During the trip, the mobile devices 130 may communication with one another and/or with servers 140 via the local network 110 of the vehicle on which the mobile device 130 users are traveling. While the examples discussed below relate to airline travel, those of ordinary skill in the art will appreciate that the systems and methods described herein may be used in any situation wherein one or more users may take advantage of the provided services.

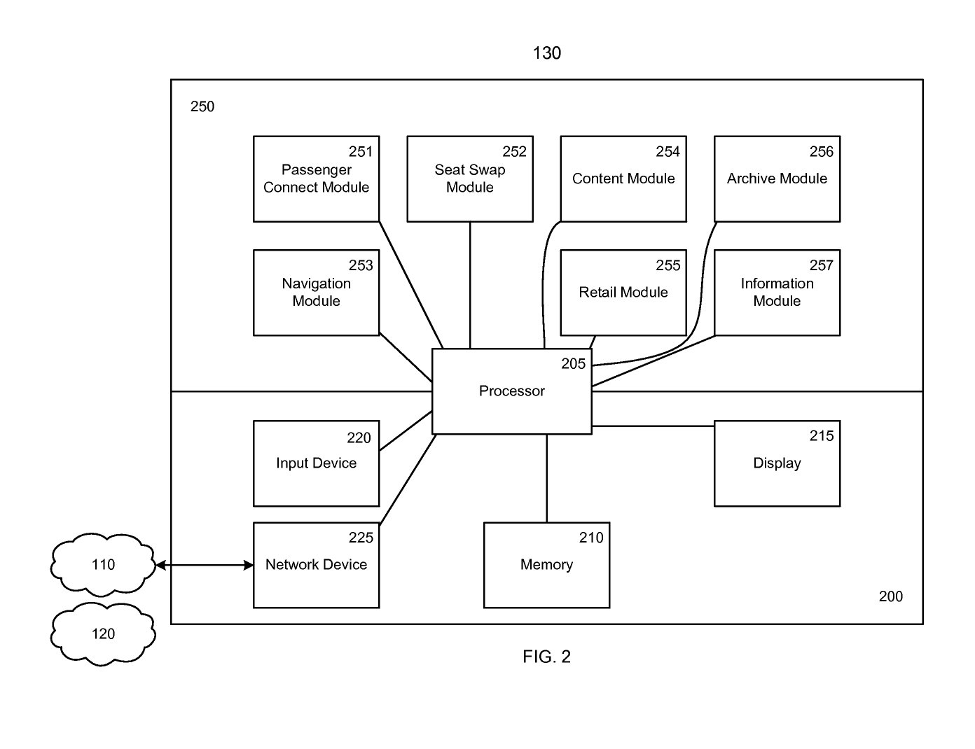

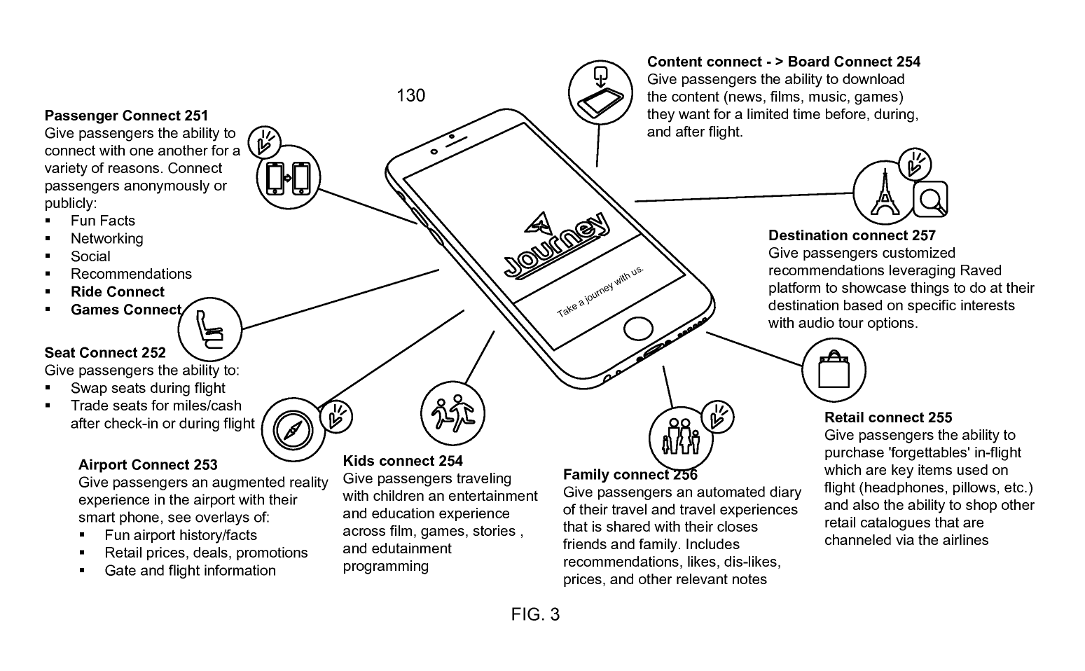

FIGS. 2 and 3 show a mobile device 130 according to an embodiment of the invention. The mobile device 130 may include hardware 200, such as at least one processor 205, at least one memory 210, at least one display device 215 (e.g., screen and/or speakers), at least one input device 220 (e.g., touchscreen, mouse, keyboard, microphone, and/or camera), at least one network device 225 which may communicate on the local network 110 and/or Internet 120 (e.g., cellular, WiFi, and/or wired network interfaces), or a combination thereof. Mobile travel service components 250 may be incorporated into and/or installed on the mobile device 130. The mobile travel service components 250 may include a passenger connect module 251, a seat swap module 252, a navigation module 253, a content module 254, a retail module 255, an archive module 256, an information module 257, or a combination thereof. These modules may direct the processor 205 and/or other components to perform various functions which may be accessible to a user through a mobile travel service user interface (UI) of the display 215 and input device 220, as described in greater detail below. For example, FIG. 3 illustrates possible features that may be provided by the modules.

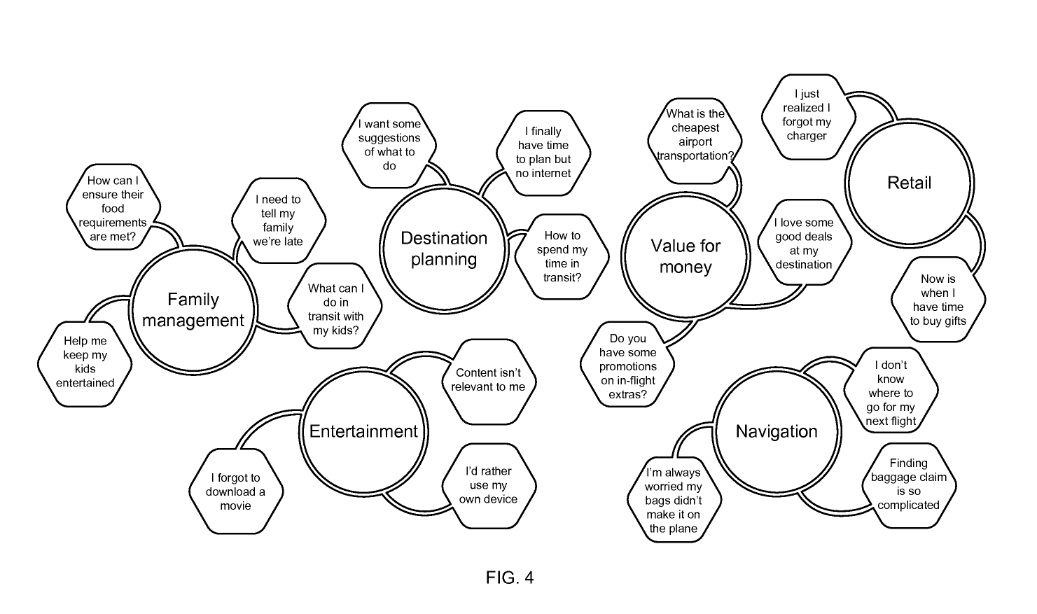

FIG. 4 is a set of mobile travel functions according to an embodiment of the invention. The functions shown in FIG. 4 may be provided by the various modules listed above and described in greater detail below.

### Passenger Connect

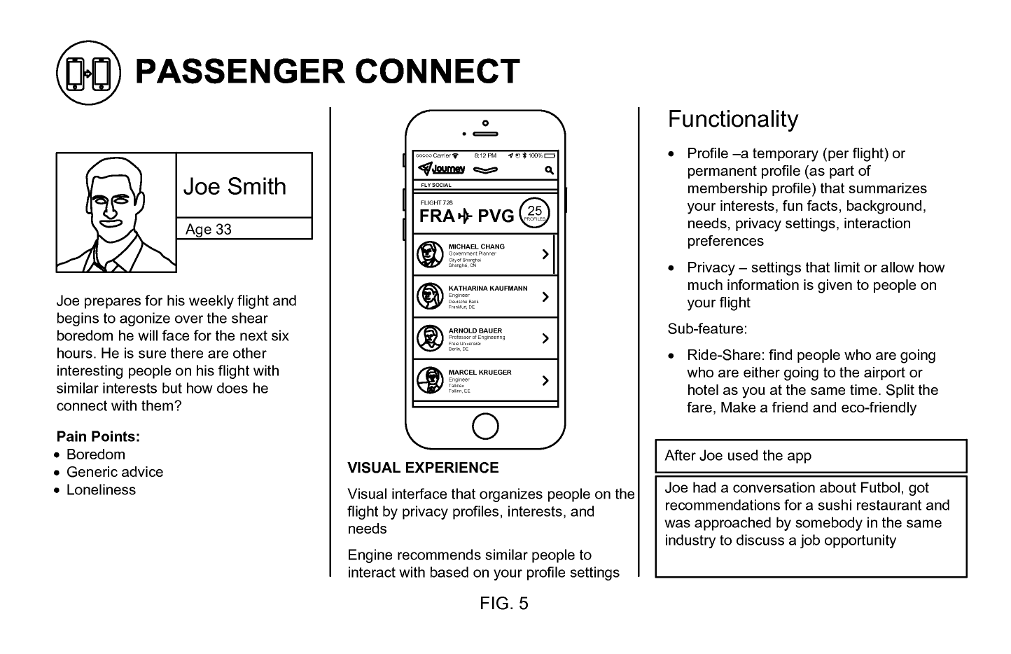

FIG. 5 is a passenger connect function according to an embodiment of the invention. The passenger connect module 251 may allow passengers to connect with one another remotely. Each user may have a profile, which may be a temporary profile (e.g., per trip) or permanent profile (e.g., as part of a membership). The profile may include information about a user's interests, fun facts, background, needs, privacy settings, interaction preferences, etc. The UI may include a passenger connect interface which may organize other travelers on the same flight. The passenger connect module 251 may organize people in a user's UI based on their privacy profiles, interests, and needs, for example. The system may recommend other users similar to the user to interact with, based on the user's profile settings. Privacy settings may allow a user to choose how much information is given to other users on the flight. A user may select another user's profile in the UI and communicate with the other user. For example, users may be able to network socially and/or professionally, share travel recommendations, arrange ride shares from the airport to common destinations, play games (e.g., competing with other individual players on the plane; competing in groups such as one side of the plane v. another, first class players v. business class players, randomly selected players; competing in groups with other groups such as players in other planes or in other locations; etc.

### Seat Swap

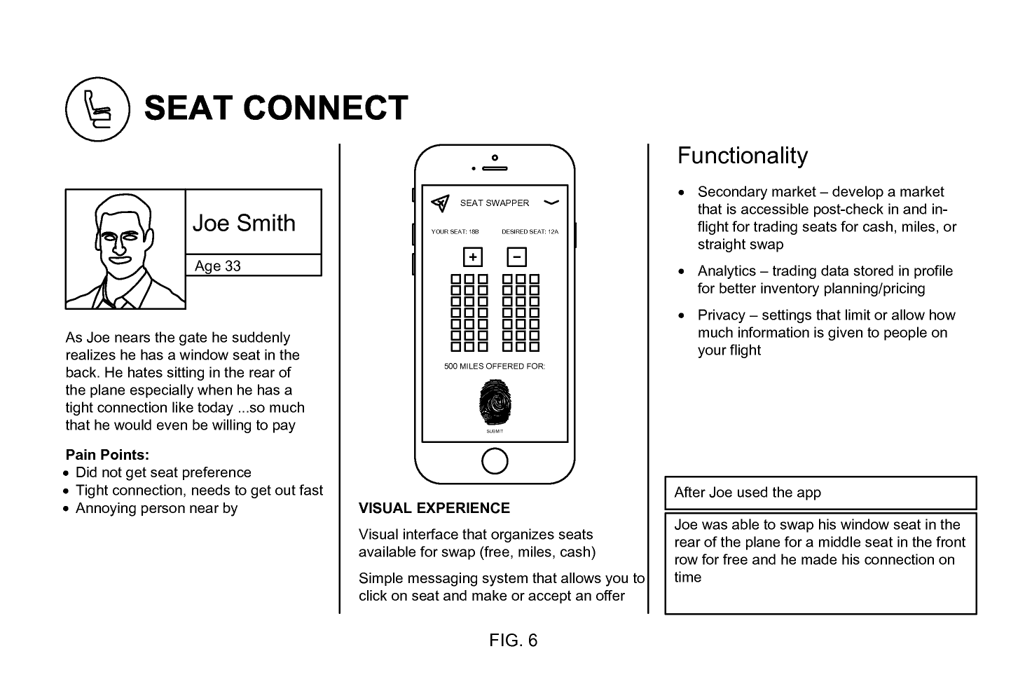

FIG. 6 is a seat connect function according to an embodiment of the invention. The seat swap module 252 may allow passengers to exchange seats with one another. For example, a user may be seated in a window seat towards the rear of an airplane. The user may dislike sitting in the rear of planes and/or may have a tight connection and may therefore be worried about getting off the plane in time. Another user may have a middle seat in the front of the plane, and may dislike middle seats but have no aisle number preference. The UI may include a seat swap interface which may allow users to indicate that they are interested in exchanging seats. Users may also be able to incentivize seat swaps. For example, the passenger sitting in the rear may be so concerned about missing her connection that she offers cash and/or miles to other passengers who are willing to swap seats with her. The UI may also show seats that other users are interested in swapping, for example on a seat map of the plane. The user in the front in the above example may see that the user in the rear is willing to give 500 airline miles to someone for a seat swap. He may indicate his willingness to exchange seats with the rear passenger in the UI. The rear passenger may be able to confirm the transaction, and the passengers may exchange seats (and miles and/or cash, where applicable). This seat swap marketplace may be available post-check-in and/or in flight. A messaging system may be integrated into the seat swap UI so that passengers can negotiate swaps in greater detail (e.g., negotiate a number of miles or a dollar value to exchange). When passengers exchange seats, the seat swap module 252 may track and store data related to the exchange, such as mile and/or dollar amounts involved in the exchange. This data may be communicated via the Internet 120 after a trip, which may allow airlines to make inventory planning and/or pricing decisions.

### Airport Navigation

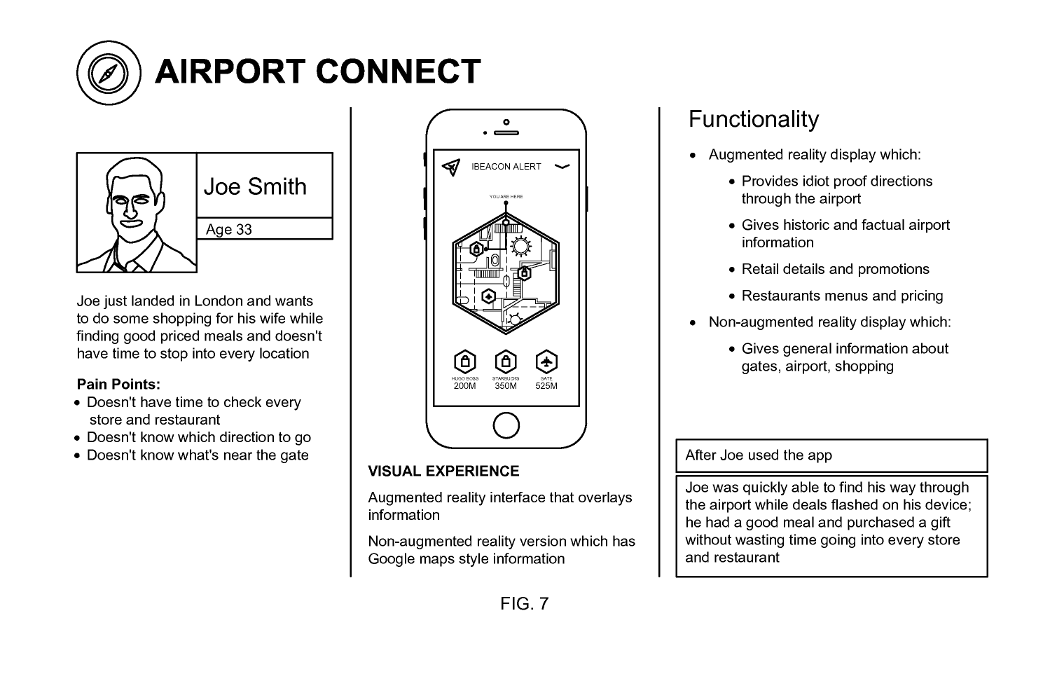

FIG. 7 is an airport connect function according to an embodiment of the invention. A user may land in an unfamiliar airport and wish to find a gate, a restroom, a restaurant, shopping, ground transportation, and/or other points of interest. The navigation module 253 may provide an augmented reality interface through the UI that may overlay information about points of interest on a view of the airport. The UI may also provide a non-augmented reality interface that may provide the information about points of interest on a map of the airport. The information may include directions to a point of interest, historical and factual information about the point of interest (and/or the airport itself), deals and/or promotions related to the point of interest, menus and/or pricing for the point of interest, and/or other information that may help the user navigate the airport.

### Kids Connect

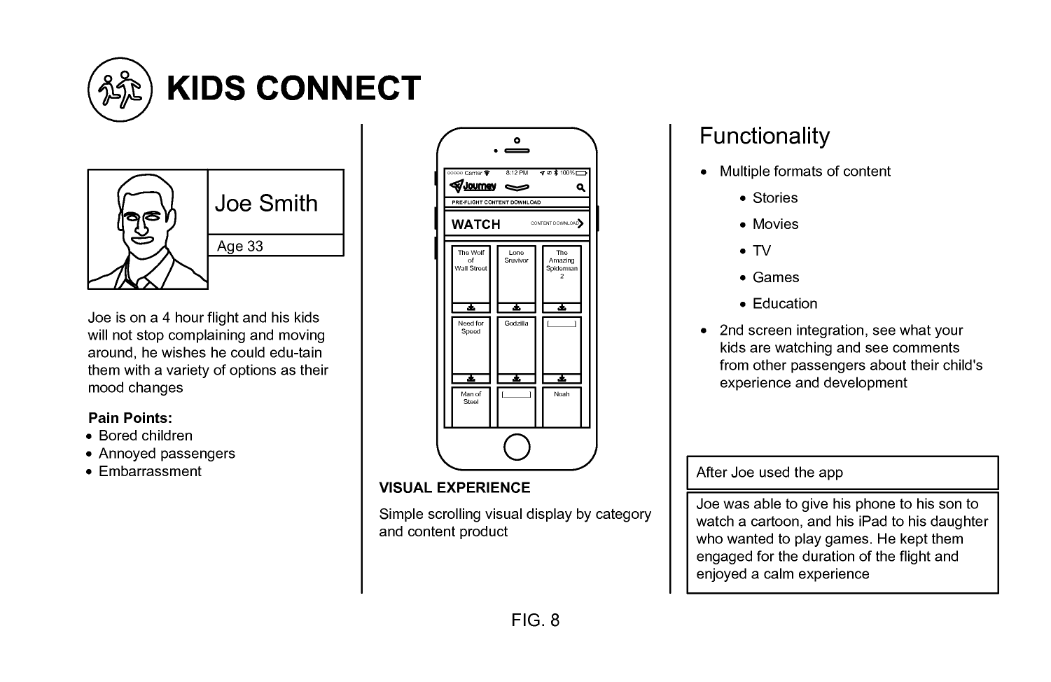

FIG. 8 is a kids connect function according to an embodiment of the invention. Some content downloaded to the device may be child-oriented. For example, games, shows, and books that are appropriate for children may be downloaded by the content module 254 and later displayed in a similar manner to the Content Connect feature discussed above.

### Family Connect

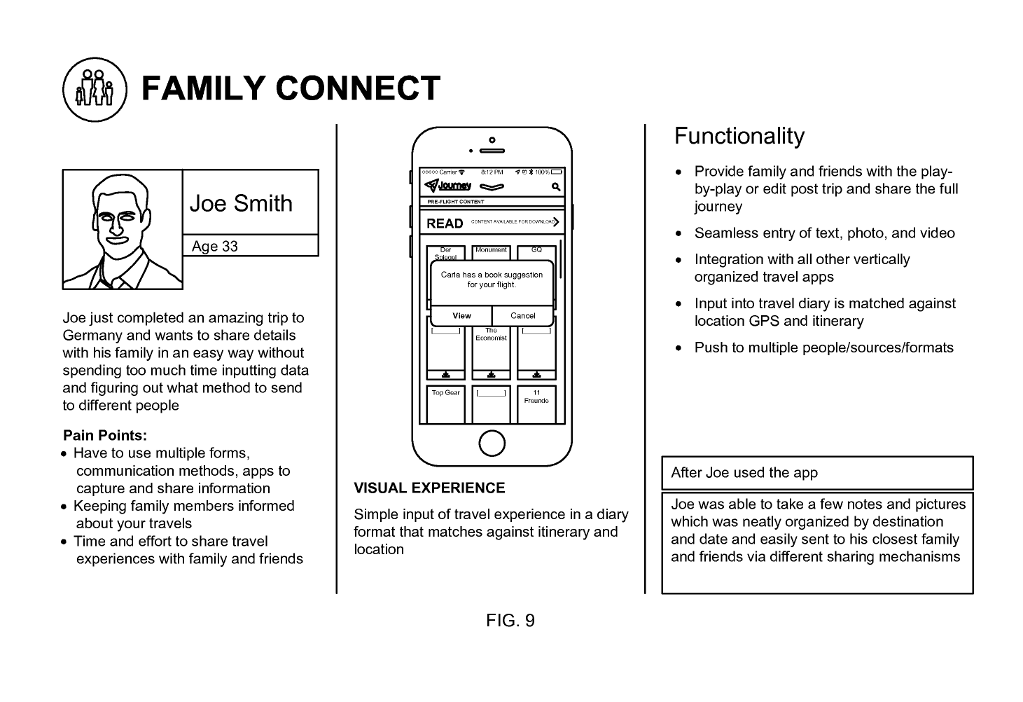

FIG. 9 is a family connect function according to an embodiment of the invention. The archive module 256 may collect data gathered by the mobile device 130 during a user's trip, such as text, photos, and/or videos, for example. The UI may make this collected data available to the user for sharing with others via any share mechanism of the mobile device 130 (e.g., social networks, email, etc.). Whenever the user gathers data with the mobile device 130 during a trip, for example by taking a photo, the archive module 256 may input this data into a travel diary. The archive module 256 may associate the data with a GPS location and/or trip itinerary, for example linking the user's photo to the location at which it was taken. The user may be able to view the travel diary before sharing and add, remove, and/or edit content. This may allow the user to share a record of their trip without having to assemble it themselves, as the archive module 256 may assemble the record in the travel diary automatically.

### Retail Connect

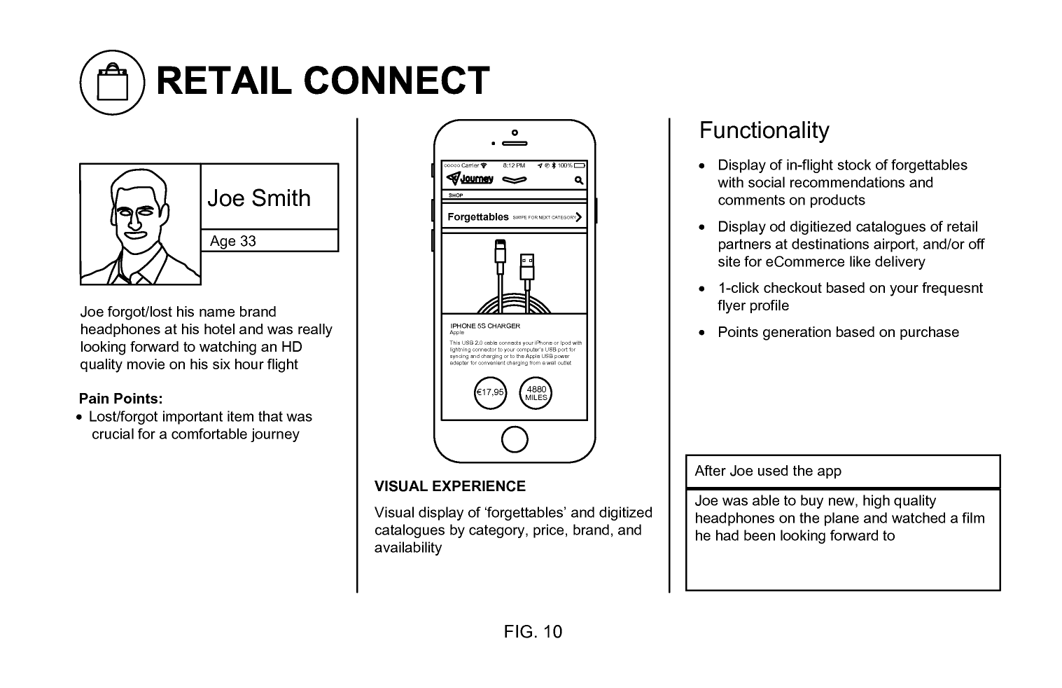

FIG. 10 is a retail connect function according to an embodiment of the invention. A user may wish to buy something during their trip. For example, a user may forget his headphones while packing but may wish to listen to music during his flight. The retail module 255 may enable shopping even while the mobile device 130 is not connected to the Internet 120 for credit card or other payment processing. The UI may display an in-flight stock of items that may be available for purchase. These items may include “forgettables” such as the headphones of this example or other items frequently desired but forgotten by travelers. The items may also include items that are not available in-flight, but which may be purchased in-flight and delivered later (e.g., to the user's hotel or home). The UI may display the items for sale in an e-commerce format, for example including information about the item, ratings and recommendations from other users, price, etc. The user may be able to purchase an item. The purchase may be linked to the user's profile. In some cases, the purchase may be linked to the user's frequent flyer profile and may earn points for the user. When an in-flight item is purchased, it may be delivered to the user upon retail module 255 receipt of the user's purchase request. For other items, a fulfillment process may begin upon retail module 255 receipt of the user's purchase request. The user's payment method (e.g., credit card) may be charged automatically when the user's device 130 establishes communications with the Internet 120 upon landing.

### Destination Connect

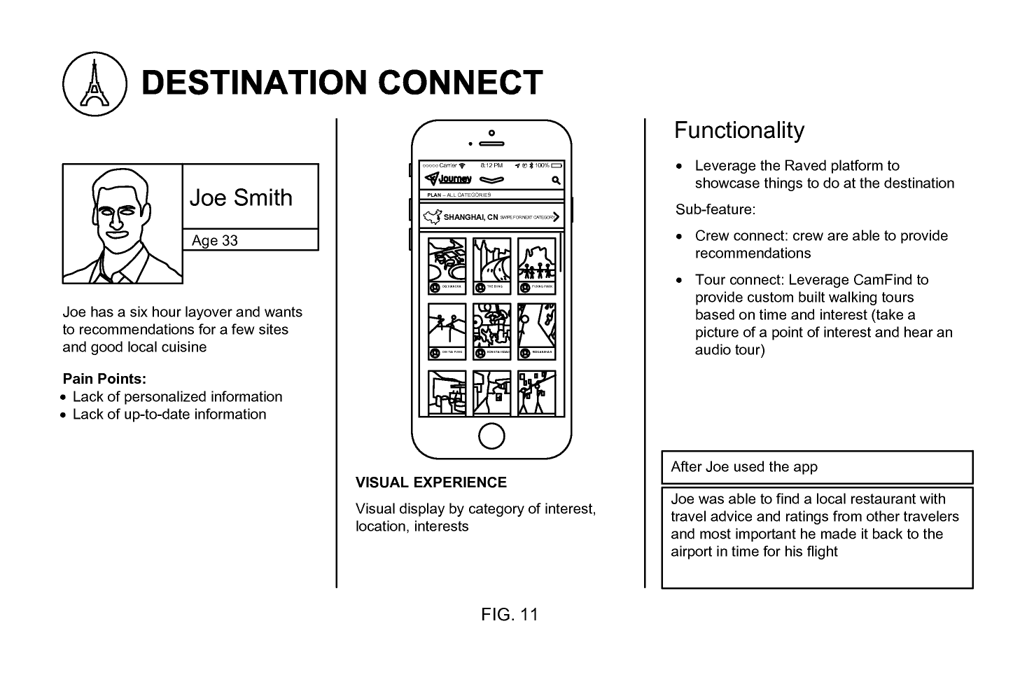

FIG. 11 is a destination connect function according to an embodiment of the invention. The information module 257 may collect and make available information about travel destinations for users. The UI may display information about the flight destination so that users can learn more about it and receive recommendations about things to do upon arrival. Users may also be able to enter recommendations and ratings of local businesses and/or attractions, which may be displayed in the UI for others. The recommendations may include recommendations by the flight crew, who may be especially familiar with the destination from frequent trips there. The UI may allow a user to assemble custom tours by selecting multiple local destinations and arranging them into an itinerary and/or directions. Audio/visual information may also be available. For example, a user may take a picture of an attraction and the information module 257 may play audible information about the attraction in response.

### Content Connect

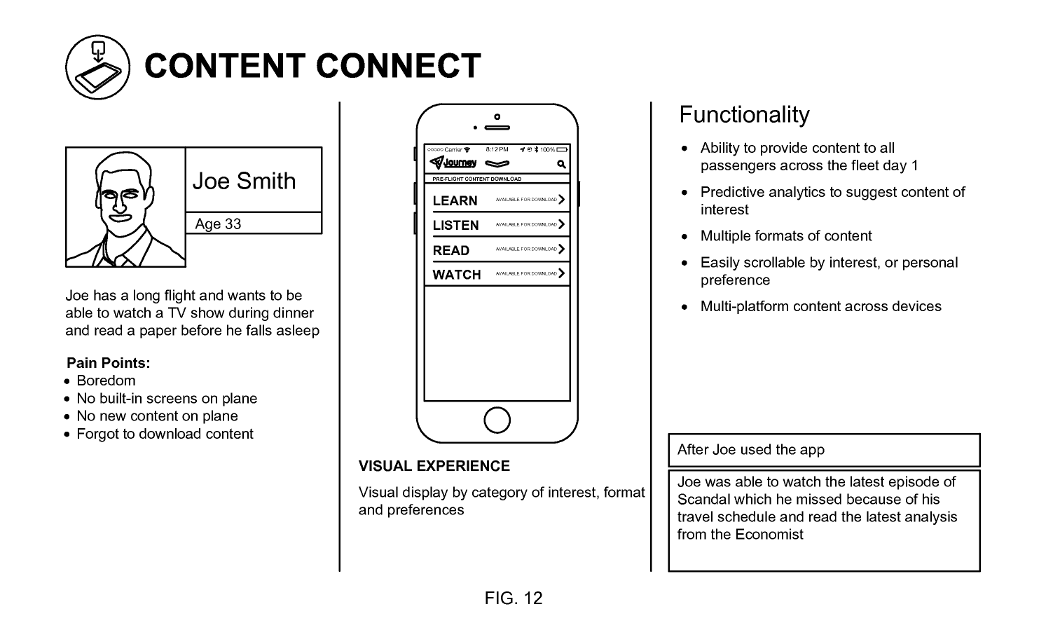

FIG. 12 is a content connect function according to an embodiment of the invention. The UI may display content to the user, such as video (e.g., films and TV shows), audio (e.g., music and audiobooks), text (e.g., books, news, and magazines), games, etc. Content may be downloaded by the content module 254 before the flight when the mobile device 130 is in range of a wireless network or connected to a wired network (e.g., the Internet 120).

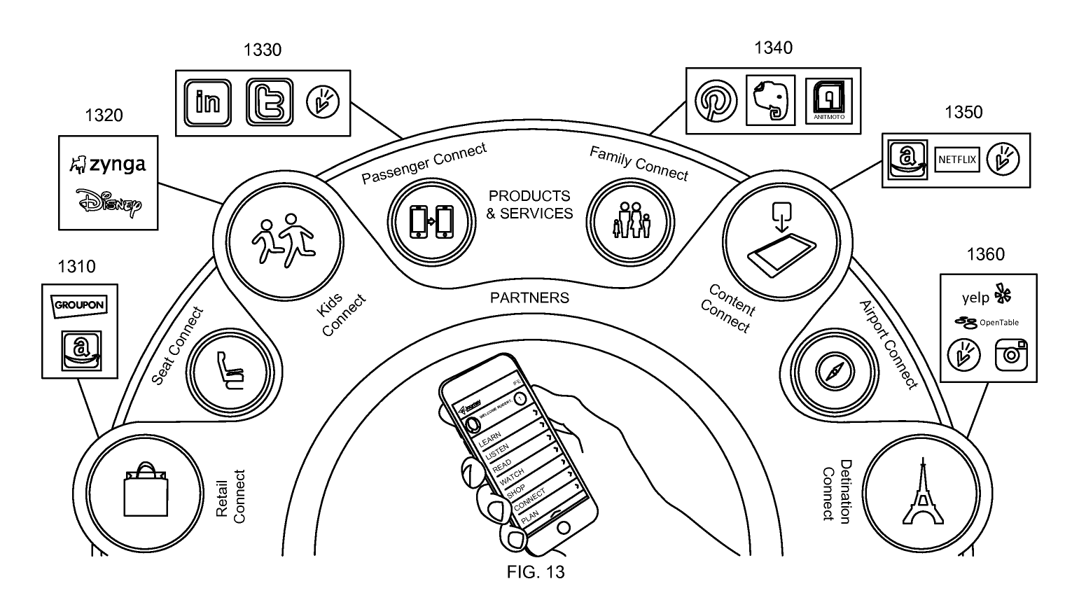

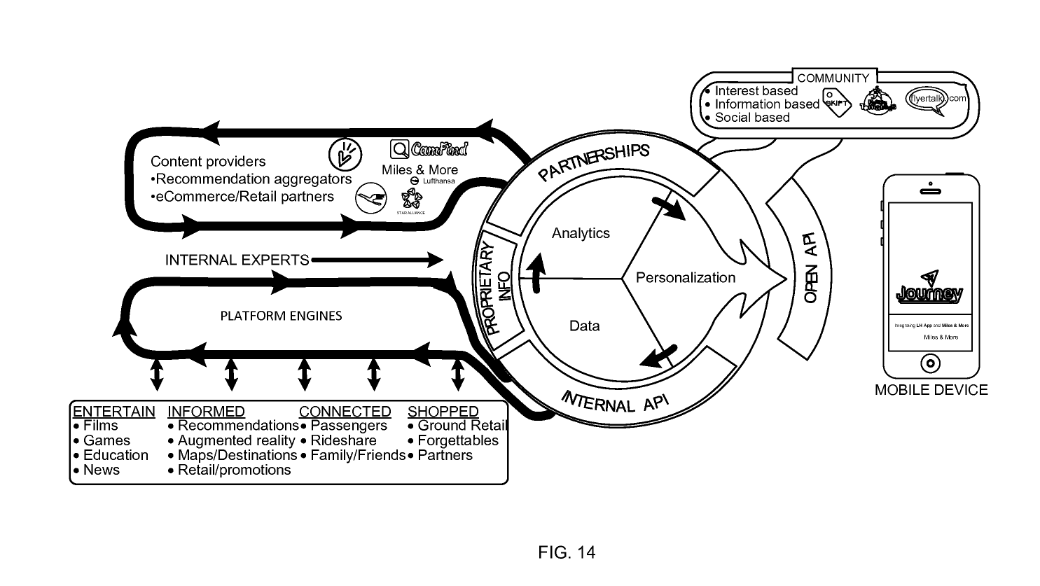

FIGS. 13 and 14 illustrate the interplay between the modules and functions described above according to an embodiment of the invention. Specifically, FIG. 13 is a platform according to an embodiment of the invention, and FIG. 14 is a network according to an embodiment of the invention. As shown in FIG. 13, the various modules and functions described above may provide access to external content providers (e.g., retailers 1310, kids' entertainment providers 1320, social networking services for individuals and families 1330/1340, entertainment providers 1350, travel information services 1360, and/or other sources). As shown in FIG. 14, external content from these providers, internal content, and/or user generated data may be integrated via the systems and methods described herein.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A mobile device comprising:
a processor;
a memory in communication with the processor;
a network device in communication with the processor, the network device configured to communicate with a local network and a public network;
an input device in communication with the processor;
a display in communication with the processor; and
at least one mobile travel service component in communication with the processor, the at least one mobile travel service component being configured to provide mobile travel services via the display and the input device when the network device is out of communication with the public network, the at least one mobile travel service component including a passenger connect module, a seat swap module, a navigation module, a content module, a retail module, an archive module, an information module, or a combination thereof.

2. The mobile device of claim 1, wherein the passenger connect module is configured to provide communication between the mobile device and at least one other mobile device via the local network.

3. The mobile device of claim 1, wherein the seat swap module is configured to provide an exchange for a seat on a vehicle associated with a user of the mobile device and at least one other seat on the vehicle via the local network.

4. The mobile device of claim 1, wherein the navigation module is configured to provide directions in an airport.

5. The mobile device of claim 1, wherein the content module is configured to download media content when the network device is in communication with the public network and cause the display to display the downloaded media content when the network device is out of communication with the public network.

6. The mobile device of claim 1, wherein the retail module is configured to accept a purchase from a user of the mobile device via the input device when the network device is out of in communication with the public network and cause a payment method to be charged for the purchase when the network device is in communication with the public network.

7. The mobile device of claim 1, wherein the archive module is configured to archive at least one input received via the input device and share the at least one archived input with at least one other device via the public network.

8. The mobile device of claim 1, wherein the information module is configured to provide information about a travel destination.
